(19) United States
(12) Patent Application Publication
(10) Pub. No.: US 2009/0305778 A1
(43) Pub. Date: Dec. 10, 2009

(54) INSTALLED GAME SOFTWARE SHARING VIA PEER-TO-PEER NETWORK

(75) Inventors: Siu-Man Yu, San Jose, CA (US); Christopher J. Dyl, Somerville, MA (US); Steven McGarry, Lowell, MA (US); John Toomey, Bridgewater, MA (US)

Correspondence Address: OCCHIUTI ROHLICEK & TSAO, LLP, 10 FAWCETT STREET, CAMBRIDGE, MA, 02138, US

(73) Assignee: Turbine, Inc., Westwood, MA (US)

(21) Appl. No.: 12/134,927

(22) Filed: Jun. 6, 2008

(51) Int. Cl. G06F 17/00

(52) U.S. Cl. 463/29; 463/42

(57) ABSTRACT

Updating a run-time version of a game stored on a first location includes causing a first swarm member to store an first version, with first game pieces, on the first location; maintaining a second game version with second pieces, some of which are missing from the first pieces; receiving, from the first swarm member, an upgrade request for the second version; identifying missing pieces; and providing, to the first swarm member, information leading to other swarm members, each of which hosts a missing piece at a second location used for storing a run-time version of the game; causing the first swarm member to retrieve the missing pieces from the second location and store them in at least a portion of the first location, thereby avoiding consumption of additional storage during the update.

### FIELD OF THE INVENTION

The invention relates to game software, and in particular, to the updating of game software.

### BACKGROUND

Known methods of upgrading game software include transmitting an installer, together with associated new pieces of game software, from a donor swarm member to a recipient swarm member. This introduces a need to maintain a copy of an installer, together with required game pieces, on the donor swarm member. As a result, storage space must be allocated at the donor swarm member.

Meanwhile, following the upgrade process, the installer remains on the recipient swarm member. As a result, space is needlessly consumed at the recipient swarm member.

Known installation methods are version-pair specific. A typical installer will typically upgrade a recipient swarm member from version n to version n+1. If one wishes to upgrade from version n to version n+m, it will generally be necessary to run m separate installations. This further complicates the distribution of upgrades.

### SUMMARY

In one aspect, the invention features a computer-implemented method for updating a run-time version of game software stored on a first storage location. The method includes causing a first swarm member to store a first version of the game software on the first storage location, the first version having a first plurality of game pieces; maintaining a second version of the game software, the second version having a second plurality of game pieces, at least one of the game pieces missing from the first plurality of game pieces; receiving, from the first swarm member, a request to upgrade to the second version of the game software, the request identifying the first version; on the basis of the identity of the first version, identifying a set of missing game pieces, the set including game pieces required to upgrade from the first version to the second version; and providing, to the first swarm member, information leading to a subset of other swarm members, each of the other swarm members from the subset hosting at least one of the missing game pieces at a second storage location used for storing a run-time version of the game software. As a result, the first swarm member receives the ability to identify other swarm members belonging to the subset and request missing game pieces therefrom. The method further includes causing the first swarm member to retrieve the missing game pieces from the second storage location and to store them in at least a portion of the first storage location that was used to store the first version of the game software, thereby avoiding consumption of additional storage during the update of the game software. The terms “first” and “second” when used in reference to the game software identify distinct, though not necessarily consecutive, versions of the game software.

In some practices the retrieved missing game pieces include game pieces for versions between the first version of the run-time game software and the second version.

Other practices of the updating method include receiving, from one or more of the other swarm members, a message identifying the swarm member as hosting a version of the game software; and generating a list of the game versions hosted by the one or more swarm members. These practices include those that also include comparing the second version included in the first swarm member's request to upgrade and the list containing the game versions hosted by the other swarm members; and based on the comparison, identifying a subset of other swarm members hosting at least one of the game pieces included in the second version.

Yet other practices of the method include receiving a message from the first swarm member upon receipt of a missing game piece, wherein the message includes the version of the game software associated with the game piece, as well as those that include causing the first swarm member to share retrieved games pieces with other members of the swarm directly from the first swarm member's first storage location.

Among the additional practices of the invention are those that include transferring between swarm members one or more game pieces in an in-place update, wherein a state of the game piece during transfer and the state of the piece after transfer, as used by the game software, are the same.

In alternative practices, causing the first swarm member to store the missing game pieces in at least a portion of the first storage location further includes causing the first swarm member to store the missing game pieces in a location from which they will be accessed during play of the game.

Other practices of the method are those in which causing the first swarm member to retrieve the missing game pieces further includes causing the first swarm member to establish a connection with the one or more other swarm members; and causing the first swarm member to terminate the connection when the first swarm member and the other connected swarm member have retrieved all missing game pieces.

Other practices of the method include those in which the missing game pieces include one or more game pieces that did not exist in the first version of the game software, and those in which the missing game pieces include one or more replacement game pieces for the first plurality of game pieces.

Yet other practices include those in which the first version is a version that immediately precedes the second version, and those in which at least a third version exists between the first and second versions.

Still other practices of the updating method are those that include providing, to the first swarm member, information leading to an identification of one or more machines hosting at least one of the missing game pieces at a third storage location used for storing the run-time version of the game software; whereby the first swarm member receives the ability to request missing game pieces therefrom; and causing the first swarm member to retrieve the missing game pieces from the third storage location and to store them in at least a portion of the first storage location that was used to store the first version of the game software.

In another aspect, the invention features a computer-readable medium having encoded thereon software for updating a run-time version of game software stored on a first location. The software comprises instructions for causing a computer to: cause a first swarm member to store a first version of the game software on the first storage location, the first version having a first plurality of game pieces; maintain a second version of the game software, the second version having a second plurality of game pieces, at least one of the game pieces missing from the first plurality of game pieces; receive, from the first swarm member, a request to upgrade to the second version of the game software, the request identifying the first version; on the basis of the identity of the first version, identify a set of missing game pieces, the set including game pieces required to upgrade from the first version to the second version; and provide, to the first swarm member, information leading to a subset of other swarm members, each of the other swarm members from the subset hosting at least one of the missing game pieces at a second storage location used for storing a run-time version of the game software; whereby the first swarm member receives the ability to identify other swarm members belonging to the subset and request missing game pieces therefrom; cause the first swarm member to retrieve the missing game pieces from the second storage location and to store them in at least a portion of the first storage location that was used to store the first version of the game software, thereby avoiding consumption of additional storage during the update of the game software.

Other embodiments have encoded thereon instructions for causing a computer to receive, from one or more of the other swarm members, a message identifying the swarm member as hosting a version of the game software; and generate a list of the game versions hosted by the one or more swarm members.

These embodiments include those that also include instructions for causing a computer to compare the second version included in the first swarm member's request to upgrade and the list containing the game versions hosted by the other swarm members; and based on the comparison, identify a subset of other swarm members hosting at least one of the game pieces included in the second version.

Yet other embodiments of the computer-readable medium have encoded thereon instructions for causing a computer to receive a message from the first swarm member upon receipt of a missing game piece, wherein the message includes the version of the game software associated with the game piece, as well as those that include instructions for causing a computer to cause the first swarm member to share retrieved games pieces with other members of the swarm directly from the first swarm member's first storage location.

Among the additional embodiments are those that include instructions for causing a computer to transfer between swarm members one or more game pieces in an in-place update, wherein a state of the game piece during transfer and the state of the piece after transfer, as used by the game software, are the same.

In alternative embodiments, instructions for causing a computer to cause the first swarm member to store the missing game pieces in at least a portion of the first storage location further include instructions for causing a computer to cause the first swarm member to store the missing game pieces in a location from which they will be accessed during play of the game.

Other embodiments of the computer-readable medium further include instructions to cause the first swarm member to establish a connection with the one or more other swarm members; and to cause the first swarm member to terminate the connection when the first swarm member and the other connected swarm member have retrieved all missing game pieces.

Yet other embodiments of the computer-readable medium include those in which the missing game pieces include one or more game pieces that did not exist in the first version of the game software, and those in which the missing game pieces include one or more replacement game pieces for the first plurality of game pieces.

Yet other embodiments include those in which the first version is a version that immediately precedes the second version, and those in which at least a third version exists between the first and second versions.

Still other embodiments of the computer-readable medium are those on which are encoded instructions for causing a computer to provide, to the first swarm member, information leading to an identification of one or more machines hosting at least one of the missing game pieces at a third storage location used for storing the run-time version of the game software; whereby the first swarm member receives the ability to request missing game pieces therefrom; and to cause the first swarm member to retrieve the missing game pieces from the third storage location and to store them in at least a portion of the first storage location that was used to store the first version of the game software.

In another aspect, in response to a request from the first swarm member to upgrade to the second version, the first swarm member receives a message from one or more of the other swarm members identifying the swarm member as hosting a version of the game software and a list of the game versions hosted by the one or more swarm members is generated. The second version included in the first swarm member's request to upgrade and the list containing the game versions hosted by the other swarm members are compared. Based on the comparison, a subset of other swarm members hosting at least one of the game pieces included in the second version is identified.

In another aspect, the missing game pieces retrieved by the first swarm member include updates for versions between the first version of the run-time game software and the second version. The retrieved missing game pieces may also be associated with the most recent version of the game software. When the first swarm member receives a missing game piece, the first swarm member sends a message that includes the version of the game software associated with the game piece.

In another aspect, the first swarm member shares retrieved games pieces with other members of the swarm directly from the first swarm member's first storage location. One or more game pieces are transferred between swarm members in an in-place update, wherein a state of the game piece during transfer and the state of the piece after transfer, as used by the game software, are the same.

In another aspect, the first swarm member stores the missing game pieces in a location from which they will be accessed during play of the game. The first swarm member also establishes a connection with the one or more other swarm members and terminates the connection when the first swarm member and the other connected swarm member have retrieved all missing game pieces.

In another aspect, the missing game pieces include one or more game pieces that did not exist in the first version of the game software. The missing game pieces may also include one or more replacement game pieces for the first plurality of game pieces. The first version is a version that immediately precedes the second version in the context of time. At least a third version exists between the first and second versions.

In another aspect, the first swarm member is provided with information leading to an identification of one or more machines hosting at least one of the missing game pieces at a third storage location used for storing the run-time version of the game software and receives the ability to request missing game pieces therefrom, and thus retrieves the missing game pieces from the third storage location and to store them in at least a portion of the first storage location that was used to store the first version of the game software.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of a game update process;

FIG. 2 is a diagram of communication between a client and a server;

FIG. 3 is an example of an Active client List;

FIGS. 4-5 are diagrams of communications between a client and a server;

FIG. 6 is a diagram of communication between a client and a data source;

FIG. 7 is a diagram of communication between clients;

FIG. 8 is a diagram of communication between a swarm and a server;

FIG. 9 is a flowchart of interactions between a seeder and client;

FIG. 10 is a flowchart of interactions between a seeder and clients; and

Like reference symbols in the various drawings indicate like elements.

### DETAILED DESCRIPTION

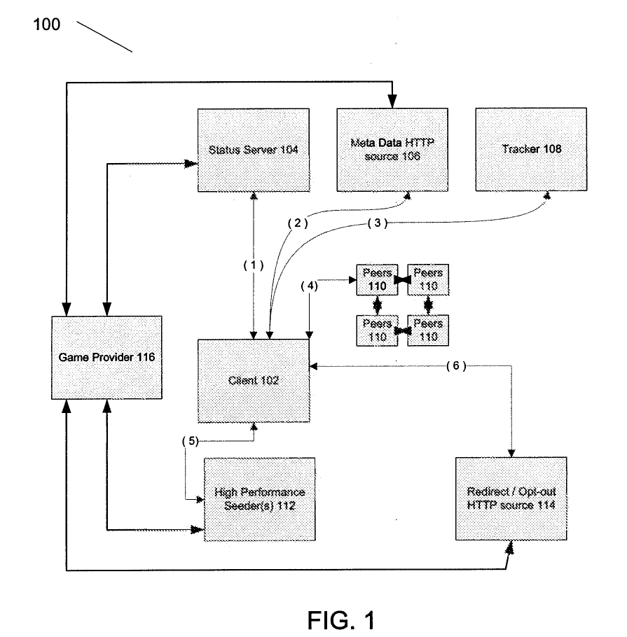

Within a gaming environment, a game provider distributes game updates of a run time version of game software to its clients through a distributed process referred to as the game update process. A run time version of game software includes the version of software that is in use during game play. Because this software is used during game play, execution of the game depends on a client's hosting the run time version of game software. In the particular embodiment shown in FIG. 1, the game update process 100 uses numerous servers hosted by the game provider and numerous game-playing clients to update game software on an updating client.

Referring to FIG. 1, a client 102 is notified of the availability of an update through communications with a status server 104. The client 102, now referred to as the “updating” client, receives meta data pertaining to the game update from a meta data source 106, such as a meta data HTTP source or other forms of meta data sources. Using the obtained meta data, the updating client 102 contacts a tracker 108 to identify other clients, referred to as peers 110, who have one or more game pieces needed to consummate the update. As used herein, a “game piece” includes image data, animation clips, sound files, executable files, and patches.

The updating client 102 establishes connections with these peers to collect the necessary pieces. The pieces are transferred to the client 102 and are applied directly to the client's other pieces or game files, without installing the pieces. A transferred piece contains all the cumulative updates for that piece. As a result, pieces are not updated in an iterative manner.

In some examples, the peers contain all the pieces included in an update, because the game uses all the update pieces during its execution. Therefore, it is likely that peers have available for transfer all the pieces needed to consummate an update and are capable of transferring these pieces directly to the client 102. If the peers are collectively unable to provide all the necessary pieces, the updating client 102 contacts a seeder 112 to request any missing pieces. The seeder 112 either directly sends the updating client 102 the missing pieces or sends the client 102 the HTTP location of a redirect HTTP source 114 containing the missing pieces.

Registration of Client with Status Server

Upon availability of a game update, the game provider 116 notifies the client 102 by causing an update invitation to be sent to the client 102. In some embodiments, the game provider uses the status server 104 to send update invitations. The game provider 116 is capable of being implemented on numerous types of machines, such as computers and portable devices. In some examples, the game provider is integrated with the server 104 (not shown).

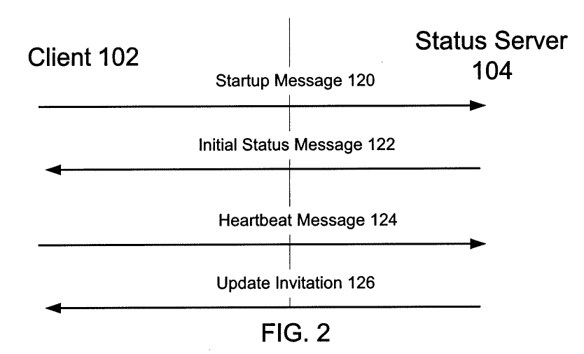

Referring to FIG. 2, to receive update invitations, the client 102 first registers with the status server 104 by sending it a startup message 120. Startup messages 120 inform the server 104 that the client 102 is capable of receiving update invitations 126.

Because the status server 104 interacts with numerous clients, each client 102 has a global unique identifier GUID. The startup message 120 contains the client's global unique identifier (GUID), thereby allowing the client 102 to uniquely identify itself to the server 104. In some examples, the startup message 120 contains additional client information, such as the client's Internet Protocol (IP) address and listening ports.

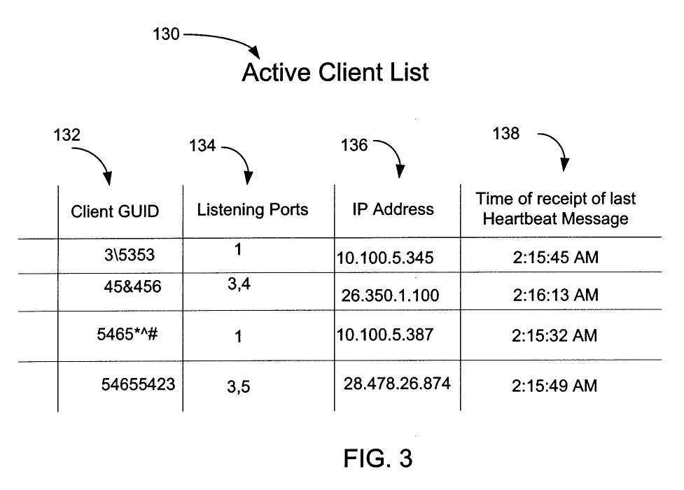

Referring to FIG. 3, to track clients 102 capable of receiving update invitations 126, the server 104 maintains an active client list 130 associating each active client with its GUID 132. Upon receipt of the startup message 120 from a client, the server 104 adds that client's GUID to the active client list 130. In some embodiments, additional information is stored in the active client list 130. Such information includes one or more of the client's IP address 138, the client's listening ports 134, and client preferences regarding the types of update invitations 126 to receive. In one example, the client 102 receives update invitations 126 pertaining only to games it already hosts, and not all available games. In these instances, the client's startup message 120 contains, and the active client list 130 stores, the list of games hosted on that client 102.

The server 104 responds to the startup message 120 by sending the client an initial status message 122. The initial status message 122 contains the current state of the content provider's data. The client 102 uses the initial status message 122 to verify the server's receipt of the startup message 120. Therefore, in some examples, the client 102 resends the startup message 120 (a second startup message) if the client 102 has not received the initial status message 122 within a specified period of time. The second startup message 120 triggers the server's sending of an additional initial status message 122 to the client 102.

After registration, the client 102 continues to communicate with the server 104 through additional messages, referred to as heartbeat messages 124. Each heartbeat message 124 informs the server 104 that the client 102 is still connected to it and capable of receiving update invitations 126. Clients 102 sending heartbeat messages 124 remain active clients and therefore remain listed on the active client list 130. For each active client on the active client list 130, the server optionally maintains the “time of receipt of the last heartbeat message” 140.

In some embodiments, the status server 104 receives heartbeat messages 124 from its active clients at predefined time intervals, referred to as “heartbeat intervals,” such as every minute or two minutes. Clients 102 that send a heartbeat message 124 within the specified time interval remain active and on the active client list 130. Clients 102 that fail to do so become inactive and are removed from the active client list 130. For example, referring to FIG. 3, if a client 102 needs to send a heartbeat message 124 every minute to remain active and the client with GUID “3\5353” fails to send a message by 2:16:45 AM, it is removed from the active client list 130, because its last heartbeat message 124 was sent over one minute ago at 2:15:45 AM.

The status server 104 detects the existence of game updates by monitoring the data changes of the content provider. For its active clients, the server 104 sends update invitations 126 when a game update is available. In some embodiments, the update invitation 126 fails to reach the client 102. To ensure that the client 102 receives all update invitations 126, each update invitation 126 includes a sequentially assigned identification number. The client 102, in its heartbeat message 124, returns to the server 104 the highest identification number it has sequentially received. The server 104 compares the identification number of the most recently sent update invitations 126 with the identification number contained in the most recently received heartbeat message 124. A difference between the two identification numbers indicates that the client 102 has not received all of the update invitations 126. In this scenario, the server 104 resends all the update invitations 126 that were sent after the last update invitation acknowledged by the client 102 in its heartbeat message 124.

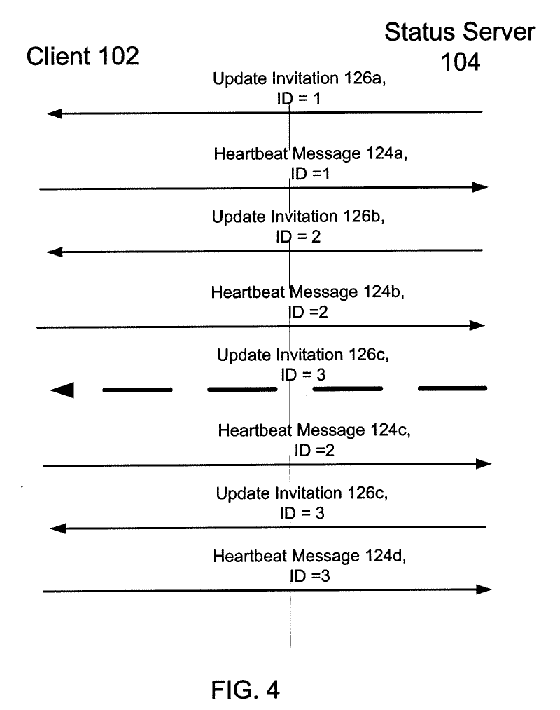

For example, referring to FIG. 4, a first invitation 126a received from the server 104 has an identification number of 1 (ID=1), a second invitation 126b has an identification number of 2 (ID=2), and a third invitation 126c has an identification number of 3 (ID=3). Upon the receipt of the first invitation 126a and the second invitation 126b, the client 102 sends the server 104 a first heartbeat message 124a, with an identification number of 1, and a second heartbeat message 124b, with an identification number of 2. However, the third invitation 126c fails to reach the client 102 (as indicated by the broken line in FIG. 4). Therefore the client's third heartbeat message 124c has an identification number of 2, indicating that the second invitation 126b was the last one received.

The third heartbeat message 124c thus alerts the server 104 that the client 102 failed to receive the third invitation 126c. Accordingly, the server 104 resends the third invitation 126c. Upon final receipt of this third invitation, the client sends a fourth heartbeat message 124d containing the identification number of 3, thus signaling that the client 102 has successfully received the third invitation 126c.

Because the server 104 sends update invitations to numerous clients, the server is capable of sending update invitations with different identification numbers to different clients. In one particular example, one client (“client A”) fails to receive the update invitation with an identification number of 3 (126c) and another client (“client B”) receives this update invitation 126c. Therefore, when the server resends the third invitation 126c to the client A as shown in FIG. 4, the server sends client B the next sequential update invitation with an identification number of 4.

The client 102 ignores any duplicate invitations. To allow for retransmission, the server retains invitations for the duration of a heartbeat interval.

### Game Updates

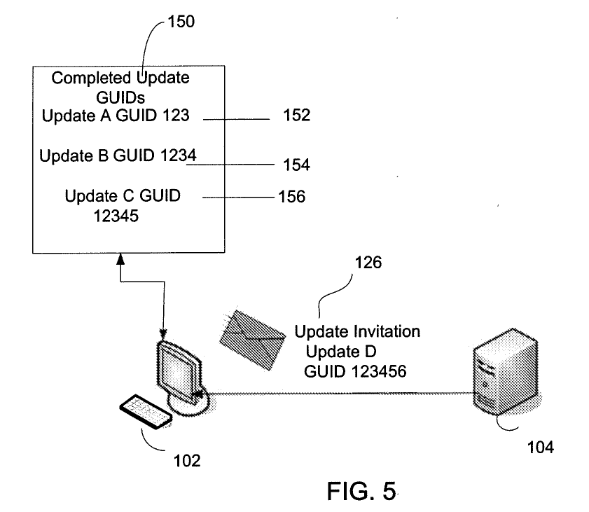

Each game update is identified by a global unique identifier (GUID) that differs from the GUID associated with the clients. The association of a GUID with a game update is referred to as a GUID update. GUID updates included in update invitations 126 alert clients 102 to new game versions. Referring to FIG. 5, the client 102 tracks its current version of the game by maintaining a record of its completed update GUIDs 150. As shown in the FIG. 5 example, update C with GUID 12345 (156) is the last completed update.

Upon receipt of the update invitation 126, the client 102 determines if it needs to obtain the new game update by comparing the client's last completed update GUID to the update GUID contained in the update invitation 126. In one example, the client 102 has completed three game updates. The first game update is update A, which has an update GUID of 123 (152). The second game update is update B, which has an update GUID of 1234 (154). The third and most recently completed game update is update C, which has an update GUID of 12345 (156). When a new game update, update D, becomes available, the client 102 receives an update invitation 126 from the status server 104 identifying the update GUID for update D. The client 102 then determines that in order to complete update D, it must obtain the game files that were newly added for update D and that it does not acquire as a result of update C. This new data that exists between updates C and D defines, in this example, the “update GUID differential.”Because in some instances the updates build on each other, a client 102 that is missing prior multiple updates needs to install these prior updates along with the most recent update in order to have the latest version of the game. Using the above example, if the client 102 had only completed update B, then the client would need to obtain both updates C and D to become completely current. In this second example, the update GUID differential consists of the game data pieces that exist between updates B and D, i.e., that are part of update D but not of update B.

### Meta Data HTTP Source

If the client 102 determines that a game update is needed, it initiates communication with the meta data HTTP source 106 that contains the meta data for the varying update GUID differentials. The meta data HTTP source 106 creates meta data each time a data update is available by processing the game update. As shown in FIG. 1, the game provider 116 notifies the data source 106 of a new game update.

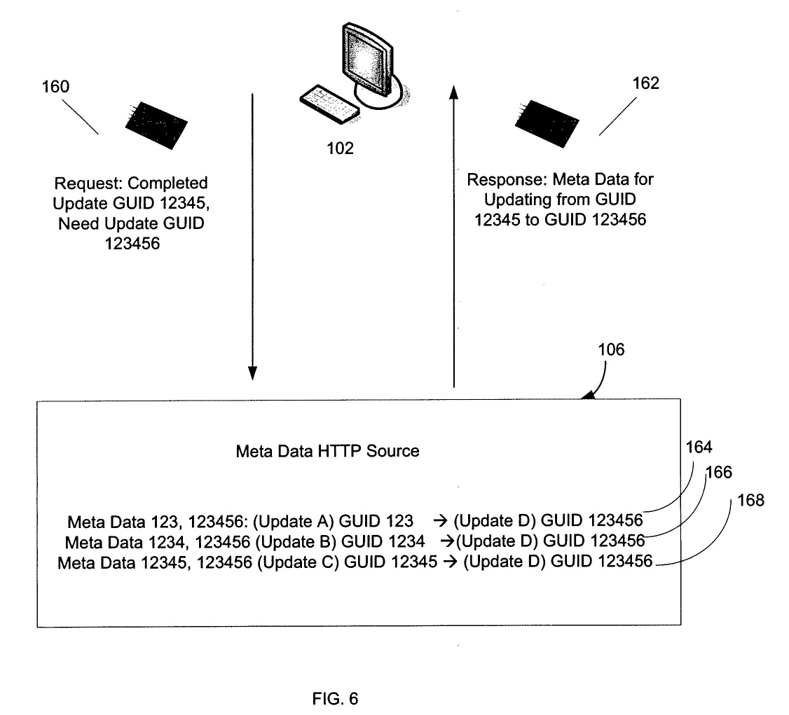

Referring to FIG. 6 and using the above example, the meta data source generates the meta data necessary to update a client 102 currently using update A, update B, or update C to the current update D (164, 166, 168). In some examples, the meta data HTTP source 106 identifies meta data by their corresponding update GUIDs. For example, meta data 123, 123456 (164) represents the meta data necessary to update a system from update GUID 123 to the current update GUID 123456.

In some examples, the meta data consists of the length of the state data, the index of the first game piece in the state data, the number of game pieces spanned by the state data, the number of bytes in each piece of data, and the concatenation of hash values for the game pieces.

The invitation 126 contains the HTTP location of the meta data HTTP source 106. The client 102 and the meta data HTTP source 106 communicate through request and response messages 160, 162. The client 102 sends a request 160 to the meta data HTTP source 106 for the meta data that corresponds to the desired update. Specifically, in one example, the request message 160 contains: the update GUID of the update most recently completed, and the update GUID of the desired update.

Based on the update GUID differential, the meta data HTTP source 106 sends a response message 162 containing the meta data for the desired update, thus providing the client 102 with a listing of the pieces that the client will need to collect before being able to complete the desire update.

In some clients 102, a component within the client 102, referred to as the “service status client,” receives and processes the update invitation. In this embodiment, a component separate from the service status client, referred to as the “update client,” communicates with the meta data HTTP source 106. The update client is a software module on the client 102. In some examples, the update client is split into two modules: the main executable and the transfer library. The main executable runs when the update client is running. It contains only the minimal code required to keep the content provider's servers aware of its existence, to accept connections from its peer clients, and to handle notifications from the service status client. The transfer library is loaded when the update GUID is transferred to the client. After a period of inactivity, this library is unloaded, to reduce the resident memory footprint when no data transfers are required. In some embodiments, this period of inactivity is 15 minutes. To preserve the user's interactive experience, the update client runs with a thread priority of below normal, allowing any foreground applications to run as needed. Further, the update client monitors the network traffic on the client's network interface card and uses the network only when traffic is low or non-existent.

In some examples, to ensure the integrity of the meta data returned to the client, the meta data is digitally signed using a public/private key mechanism. In some embodiments, secure hash algorithms (SHA1) are used as hashing codes.

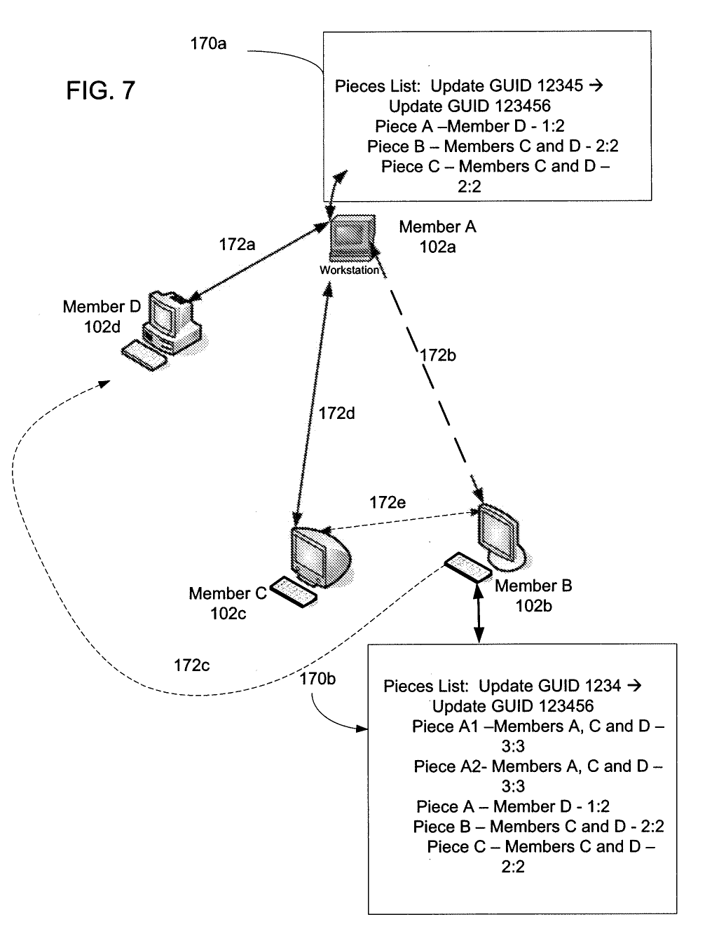

Referring to FIG. 7, using the meta data identified in the meta data HTTP source's response 162, the client 102a, 102b builds a list of the game pieces that it needs to complete its desired update. This list is referred to as the “piece list” 170a, 170b. For example, piece list 170a illustrates that three game pieces (pieces A, B and C) are required to update client 102a from GUID 12345 to GUID 123456. Similarly, piece list 170b illustrates that five pieces (pieces A1, A2, A, B and C) are needed to update a client 102b from GUID 1234 to GUID 123456. In some examples, the client compares the meta data to its local data to determine if it already has any of the pieces identified in the meta data (not shown). For example, if the client 102 started an update but failed to complete it, thus resulting in a partial update, the client 102 may already have some of the pieces identified in the meta data HTTP source's response 162.

### Tracker

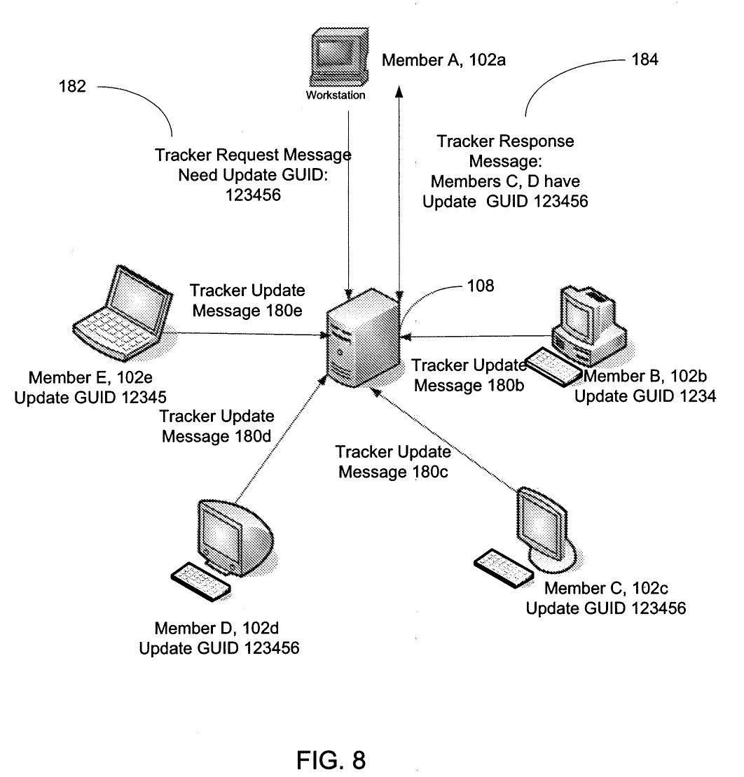

In some examples, the updating client 102 is a member of a swarm that includes other clients, all of whom host some version of the game. In such cases, the updating client 102 obtains the missing pieces from these other swarm members, or peers 110. Each client within the swarm is referred to as a “swarm member.” For example, referring to FIG. 8, swarm members include A, B, C, D, and E (102a-102e). Swarm members host different versions of the game provider's game, with the particular version being identified by the swarm member's update GUID. For example, swarm member B 102b hosts update GUID version 1234. Swarm members C and D 102c, 102d host update GUIDs versions 123456. Swarm member E 102e hosts update GUID version 12345.

The tracker 108 identifies the game version used by each swarm member. It does so by associating swarm members 102a-102e with their respective update GUIDs. However, in some examples, the tracker 108 is a versioning server and does not identify the particular game pieces located on swarm members 102a-102e. Therefore, the tracker 108 does not differentiate between those swarm members that have some but not all of an update GUID's game pieces and those swarm members that have all of an update GUID's game pieces. If a swarm member 102a-102e has at least some of an update GUID's game pieces, the tracker 108 identifies that member as using the update GUID. For example, referring to Table 1, the tracker 108 identifies members C and D (102c, 102d) as hosting a game version identified by update GUID 123456, member B (102b) as hosting a game version identified by update GUID 1234, and members A and E (102a, 102e) as hosting a game version identified by update GUID 12345.

TABLE 1

| Swarm member | |
|---|---|
| GUID | Update GUID |
| A | 12345 |
| B | 1234 |
| C | 123456 |
| D | 123456 |
| E | 12345 |

Upon joining the swarm 102b-102e, a member 102a sends a message to the tracker 108 in which it registers with the tracker 108 and notifies the tracker 108 of its willingness to offer game pieces to other swarm members. Swarm members 102b-102e send periodic tracker update messages 180b-180e to the tracker 108. A tracker update message 180b-180e from a swarm member informs the tracker 108 that that swarm member is still active and available to provide game pieces to other swarm members. The tracker update messages 180b-180e also include the version of the game used by the member, as indicated by the update GUID. If the tracker update message includes an update GUID that differs from the update GUID previously associated with that member, the tracker 108 changes the member's associated update GUID to the more recent one. In one example, referring to Table 1 above, member A is initially associated with update GUID 1234 (not shown). A subsequent update message 180b-180e indicates that member A is using a more recent game version with an update GUID of 12345. The tracker 108 updates member A's associated update GUID to reflect member A's use of the version with update GUID 12345. The tracker 108 maintains a list of those swarm members that regularly send tracker update messages 180b-180e. In some embodiments, swarm members 102b-102e send tracker update messages 180b-180e at predefined intervals, referred to as time-out intervals, such as every one or two minutes. The tracker 108 removes from its list those swarm members from whom no message has been received within the time-out interval. For example, if the time-out interval for sending the tracker update messages is one minute, and a swarm member has not sent a tracker update message for over a minute, that swarm member's connection with the tracker 108 is terminated, and that swarm member is removed from the active swarm member list.

In systems where the tracker 108 is a versioning server, the tracker update message 180b-180e contains the update GUID used by the swarm members. The messages 180b-180e also contain the swarm member's contact information, such as the swarm member's IP address and listening port.

The active swarm member list also maintains both seeding and updating data for each member. “Seeding data” refers to the game pieces that the swarm member uploads to other swarm members. “Updating data” refers to the game pieces that a swarm member is currently downloading on its system. For seeding, the tracker 108 logs the list of the game updates the member is seeding and the total number of bytes uploaded for the updates since the member started seeding. For updating, the tracker 108 maintains a list of the game update that the member is currently downloading, the total number of bytes downloaded for this update since the member started downloading, and the number of bytes remaining to be downloaded.

The tracker 108 and the swarm members 102a-102e communicate by request 182 and response 184 messages. The request message 182, which comes from an updating swarm member, contains the update GUID for that swarm member's desired game update. Upon receiving the update request, the tracker 108 compares the update GUID of the swarm member's desired update with the update GUIDs of the other swarm members 102b-102e. It then sends a response message 184 to the updating swarm member containing the list of other swarm members from which the updating swarm member 102a may obtain the required update GUID. For example, referring to FIG. 8, swarm member 102a identifies in its request message 182 that it requires update GUID 123456. In response 184, the tracker 108 informs the swarm member 102a that swarm members C (102c) and D (102d) are both using update GUID 123456.

The response message 184 also includes the swarm member's contact information. As a result, swarm members 102a-102e can communicate directly with one another. Therefore, the response message 184 lists the member's update GUID, internet protocol address and listening ports, along with alternate internet protocol addresses. In some embodiments, the maximum number of peers returned is configurable on the tracker 108. This allows a swarm member to avoid receiving notice of all swarm members whose update GUID matches the update GUID needed by the member.

### Peers

Referring back to FIG. 7, using the member information contained in the tracker's response message 184, an updating swarm member 102a establishes peer connections 172a-172e with those swarm members 102b-102d from whom it expects to collect game pieces to complete its update.

Upon establishing a peer connection, the members 102a-102d exchange information concerning the game pieces of the update GUID each has obtained or needs. Over the peer connection, game pieces are transferred between swarm members 102a-102d. Each piece includes the cumulative update for that piece, thus allowing a member to bypass all intermediate versions to update to the most recent version in only a single step. Because the game pieces are not part of an installer, transferred game pieces are deposited directly into the updating swarm member's location for the hosting of game pieces or are deposited into the updating swarm member's game files. Because members 102a-102d do not need to download and execute installers, disk space on the members' systems is not devoted to these extraneous files.

In one example, because the tracker 108 has informed swarm member A 102a that swarm members D 102d and C 102c contain the update GUID 123456, the update GUID needed by swarm member A, swarm member A communicates with swarm members D and C over communication channels 172a and 172d, requesting that they identify their hosted update GUID 123456 game pieces. Accordingly, swarm members D and C respond with the game pieces they host for update GUID 123456. Analogously, swarm member B performs a more extensive update in which it jumps from update GUID 1234 all the way to update GUID 123456. Because swarm members A, C, and D all include game pieces required by swarm member B to complete update GUID 12456, swarm member B establishes communication channels 172b, 172c, 172e with swarm members A, C and D.

Based upon these member exchanges, swarm members add to their “pieces list” 170a, 170 by adding an availability map detailing the game pieces held by other swarm members. Referring to Table 2, a rarity score indicates the frequency of each game piece's occurrence within the swarm. In some examples, the rarity score is a ratio of the number of swarm members hosting a game piece for a specific update GUID to the number of swarm members using the specific update GUID. For example, when moving from update GUID 12345 to update GUID 123456, three game pieces complete the update: piece a, piece b and piece c. Using the above example, member D has notified member A that it has all three pieces. Likewise, member C has notified member A that it has pieces b and c. Because only one member (member D) out of the two members (members C and D) using update GUID 123456 has game piece a, game piece a has a rarity score of 1:2.

TABLE 2
pieces List: Updating from GUID 12345 to GUID
123456

| | |
|---|---|
| Availability Map | Rarity Score |

| | | |
|---|---|---|
| piece a | Member D | 1:2 |
| piece b | Members C, D | 2:2 |
| piece c | Members C, D | 2:2 |

Swarm members continuously and simultaneously request the game pieces that they need to complete their respective updates. In doing so, they request the rarest pieces first. This ensures that rare pieces do not stay rare for long, by quickly propagating them throughout the swarm.

After a swarm member (“the requesting swarm member”) requests a game piece, a supplying swarm member receiving the request and performs a data push to transfer the requested game piece to the requesting swarm member. The game piece is directly applied to the updating member's location for hosting game pieces, replacing the prior, corresponding game piece, if one exists. Because the game piece is directly applied to the member's game files, the game piece is automatically usable by the game without the installation, download or execution of any additional files, such as installation files. Upon receipt of the game piece, the requesting swarm member updates its availability map to indicate that the game piece is no longer needed. Additionally, since it now has a newly obtained game piece, the requesting swarm member is now capable of redistributing it throughout the swarm, thus speeding propagation of game pieces. As this propagation continues, the rare game piece becomes less rare.

Upon receipt of a game piece, the requesting swarm member initiates the propagation process by notifying other swarm members with which it has a peer connection, causing these other swarm members to update their availability maps and rarity scores and to request this game piece from the requesting swarm member, who can now act as a supplying swarm member. Supplying swarm members directly transfer game pieces to requesting swarm members, without the use of an installer. As a result, there is no need to maintain space for a separate installer. Moreover, since no installer is used, it is no longer possible to opt out of being a supplying swarm member by simply deleting the installer, as was the case in the prior art.

For example, referring to FIG. 7, after member A receives piece a, member A notifies member B that it now hosts piece a of update GUID 123456. Therefore, if member B has not yet received piece a, member B updates its availability map to indicate that member A now hosts piece a and to change piece a's rarity score to 3:3, thus denoting that out of the three members (members A, C and D) using update GUID 123456 all three members contain piece a.

Swarm members establish peer connections periodically and in batches, such as in batches of five. The number of peer connections a swarm member is capable of establishing is limited by the number of connections the swarm member and its potential peers are capable of supporting, which is partly dependent on connection types and bandwidth capabilities.

Once a connection is established, a swarm member keeps a few unfulfilled requests on each peer connection to speed the download process. Upon the download of one game piece, the download of a second game piece is automatically initiated because the request for this second game piece would already have been sent by the swarm member and received by the peer. If the peer connection did not contain unfilled requests, then upon download completion of one game piece, the swarm member would request the second game piece. On connections with high BDP (bandwidth-delay-product, high latency or high bandwidth), this would result in a substantial performance loss.

### Continuous Sharing Between Members

As previously discussed, members performs updates in place by directly transferring pieces to one another. During an in-place update, the state of the pieces during transfer and the state of the pieces after transfer, as used by the game, are the same. That is, the pieces are transferred amongst members in their original state: the state of the pieces as they are used by the game, without the addition of an installer or install files.

Additionally, a member usually requires all the updated pieces to properly execute the game. Therefore by simply hosting the game pieces, members broadcast the game pieces to other members, because the game pieces are transferred in the same state as they are hosted in. As a result, in most situations, all of the game pieces required for an update are both held in the swarm and are broadcast amongst the members.

### Choking Between Peer Members

In some embodiments, a swarm member ignores or denies another swarm member's request for game pieces. In recognition of this, swarm members maintain state information for their peer connections, indicating peers' receptiveness. When a peer denies an updating swarm member's request, the peer's request denial is referred to as “choking” the updating swarm member. When choked by a peer, the updating swarm member avoids sending requests for game pieces to that peer, because those requests are being rejected by the peer.

Choking is done for several reasons, as among which is a failure of congestion control, such as the Transmission Control Protocol (TCP). TCP congestion control behaves poorly when game pieces are sent over many peer connections at once. Choking limits the number of simultaneous uploads and thus peer connections, thereby improving good TCP performance.

While using TCP congestion control, a swarm member is still capable of identifying the peers with which is wants to establish connections. For example, a swarm member often chooses to send game pieces to peers that have previously sent it game pieces, an exchange referred to as “reciprocation.” Therefore, a swarm member does not choke its reciprocation peers. Additionally, a swarm member does not choke peers capable of quickly uploading data, because these peers do not contribute to congestion.

A swarm member is typically most interested in establishing communication with peers that host whatever game version that swarm member needs. Therefore, a swarm member requests game pieces from those peers that are not choking it and that have low rarity scores for those game pieces that it needs.

It is important for each swarm member to keep its peers informed as to whether or not it is interested in them. Each swarm member keeps this state information up-to-date for all its peers, including those peers that are currently choking it. This allows each peer to know if unchoking a swarm member would cause it to begin downloading.

### Seeder

In addition to receiving game pieces of the update GUID from other swarm members (i.e., peers), an updating client 102 also receives game pieces from a seeder 112. Because most members host all the updated game pieces and thus share these updates directly with other members, as previously discussed, members do not request pieces from the seeder 112 very often.

When an update becomes available, the game provider 116 places the corresponding game pieces on the seeder 112. The seeder 112 maintains a table that lists the game pieces corresponding to each update. To the updating client, the seeder 112 appears to be just another swarm member that is uploading game pieces to it. In some embodiments, multiple seeders 112 perform the functions described above.

When the entire swarm lacks a particular game piece, the swarm is said to be “starved” for that game piece. In such cases, an updating client 102 obtains game pieces directly from the seeder 112.

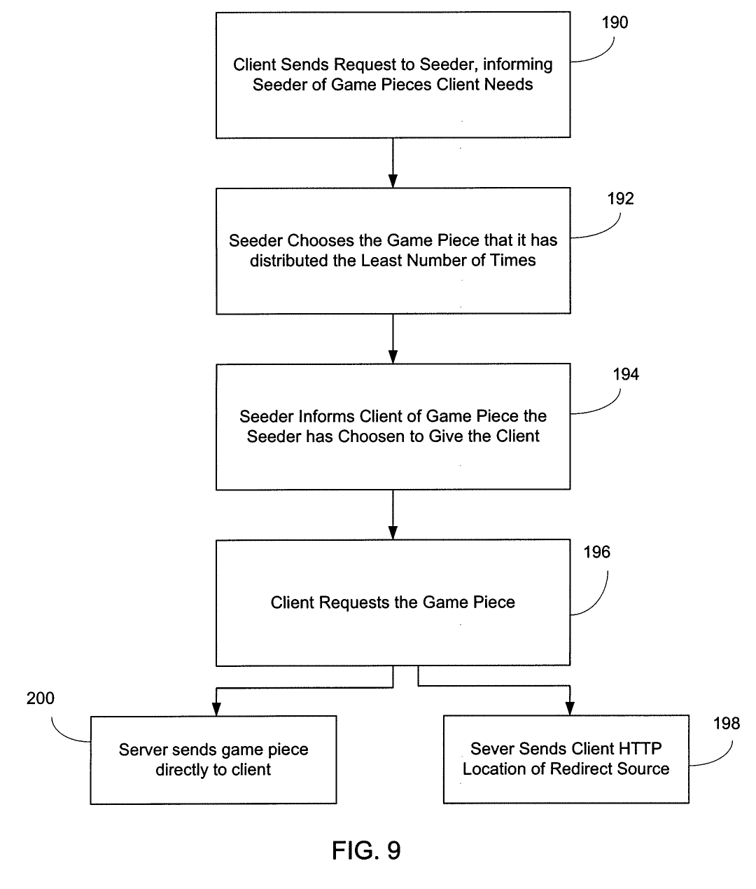

The seeder 112 also participates when the updating client experiences suboptimal download throughput from swarm members. In this scenario, the client supplements its download speed by obtaining additional game pieces from the seeder 112. However, to ensure the efficiency of the seeder 112, the seeder 112 may limit the number of game pieces it will give to the client 102 due to a suboptimal download speed. The seeder 112 also limits the number of game pieces in case the suboptimal download throughput is alleviated, in which case the client 102 may obtain game pieces from its peers. Referring to FIG. 9, the client 102 initiates the retrieval of game pieces from the seeder 112 by sending it a list of the game pieces it has been unable to obtain through the swarm 190. From these client-identified game pieces, the seeder 112 chooses to give the client the rarest game piece, i.e., that game piece it has given out the least number of times 192. This encourages propagation of rare data pieces throughout the swarm, as previously discussed. Therefore, the seeder 112 avoids distributing a game piece if a large number of swarm members have the game piece and the client could easily obtain the game piece from the swarm. However, in a brand new game, no swarm members possess the game pieces. Therefore, the seeder 112 makes an initial distribution of the game pieces.

In response to the client's request, the seeder 112 tells the client which game piece that it has chosen to give it 194. The client then proceeds to request the game piece 196. In some examples, the seeder 112 responds to this request by directly serving the game piece to the client 200. However, in other examples, the seeder performs a “seeder redirect,” informing the client of the HTTP location (“redirect source,” 114 FIG. 1) where the game piece is available 198. In some examples, the seeder 112 does this by including a redirect URL in its response to the client's request. In some instances, a seeder redirect occurs when the seeder nears its upload capacity. The client then contacts the HTTP location to download the pieces.

The seeder 112 or the HTTP seeder redirect source transfer game pieces directly to the client's game files so that the client may immediately begin using the game piece. Upon receipt of a game piece from either the seeder 112 or the HTTP seeder redirect source, the client updates its “piece list,” 170a, 170b to indicate that it no longer needs the newly-obtained game piece. Additionally, the client notifies its other connected swarm members of this newly-obtained game piece, allowing them to update their own respective piece lists and, if necessary, to request the game piece from the client. In this way, rare game pieces are propagated throughout the swarm without additional seeder intervention.

Because the updating client 102 remains connected to numerous swarm members while still connected to the seeder 112, the number of game pieces the updating client will need from the seeder 112 may change after other swarm members receive new game pieces from the seeder 112 and notify the client 102.

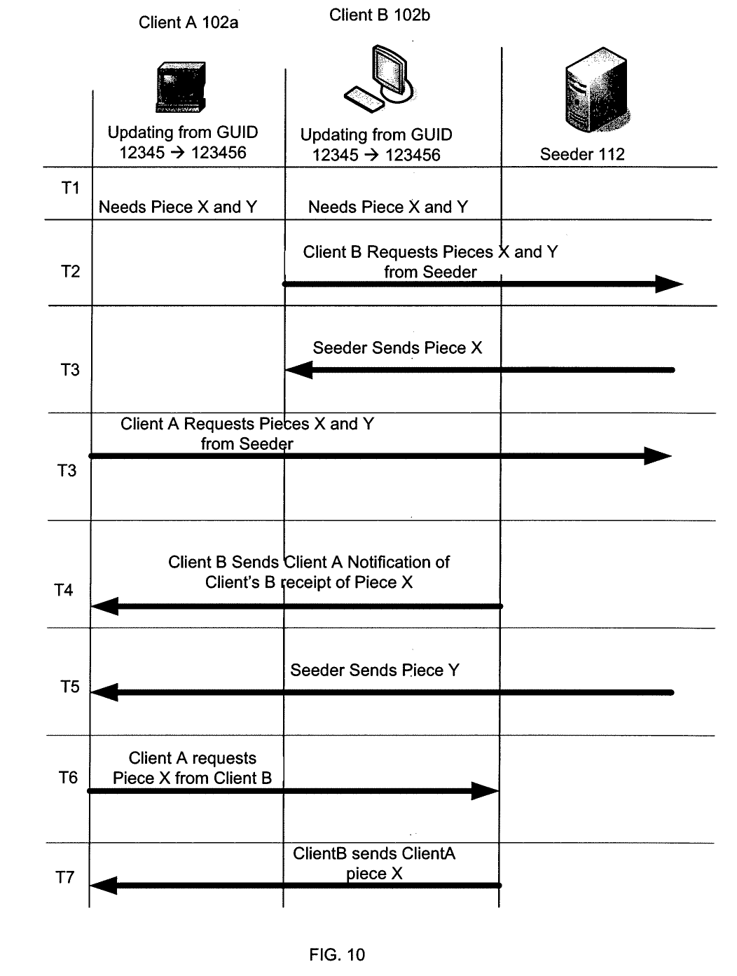

For example, referring to FIG. 10, at time T1, client A 102a and client B 102b both need pieces x and y of update GUID 123456. At time T2, client B 102b requests pieces x and y from the seeder 112. Because piece x occurs less frequently throughout the swarm, at time T3, the seeder 112 sends piece x to client B 102b. Concurrently at time T3, client A, having yet to be notified that client B has already received piece x, requests both pieces x and y from the seeder. However, at time T4, client B notifies client A of its receipt of piece x. Accordingly, client A updates its availability map to indicate that piece x may now be obtained from client B instead of from the seeder. At time T5, the seeder sends client A piece y, as this piece has not been propagated throughout the swarm and thus client A may not easily obtain this piece elsewhere. Piece y is directly transferred to the client's game files and no further actions are required for the piece to be executed or otherwise used by the game during play. Client A then requests piece x from client B at time T6 and receives it at time T7. Piece x is directly transferred to Client A in the manner just described. As a result, client A no longer needs to obtain this piece from the seeder, as it had originally requested.

In some instances, an updating client 102 requests, from the seeder 112, a game piece recently distributed to another swarm member by the seeder 112. This happens when the client 102 requests a game piece from the seeder prior to receiving another swarm member's notification message of having received the game piece. This situation is illustrated at time T3 in FIG. 10, where client A, unaware that another client (client B 102b) already has piece a, requests piece a from the seeder. This may occur when the seeder provides piece a to client B at about the same time that client A requests it from the seeder.

To avoid this inefficiency, in some embodiments, the seeder 112 tracks the time of a game piece's most recent distribution and avoids redistributing the same game piece within a predefined wait interval preceding its most recent distribution. Therefore, if the client requests a previously distributed game piece within the wait interval, the seeder 112 does not upload the data piece to the client.

As discussed above, a client 102 may visit the seeder 112 when the swarm is starved for a requested game piece or when requesting the game piece from another swarm member would result in a suboptimal download throughput. Depending on the reason for contacting the seeder 112, the seeder's throughput varies. In the first case, when the swarm is starved for a game piece, there is no diminished throughput, because the swarm cannot possibly supply the requested game piece. However, in the second case, since it is not absolutely necessary for the updating client 102 to contact the seeder 112, the updating client's throughput is diminished to discourage it from unnecessarily contacting the seeder 112. This conserves the seeder's resources.

In some embodiments, the functions of a seeder are distributed among the swarm members, and performed locally by each swarm member. Because each swarm member is aware of rarity scores, each swarm member is aware of game piece availability among its peers. As a result, a swarm member can make intelligent decisions locally as to what game piece it needs to request. The swarm member can then request such pieces directly from the redirect HTTP source, without the use of the seeder 112. Such embodiments, which do not require a dedicated seeder 112, are referred to as having a “seederless” architecture.

### Opt-Out HTTP Source

In some embodiments, the updating client opts out of the swarm, and declines to use the tracker 108, seeder 112, or any peers to obtain game pieces. Instead, the client uses the meta data of the update GUID and obtains the game pieces directly from an opt-out source, such as a HTTP source or any form of data source capable of distributing game pieces. As shown in FIG. 1, for each new game update, the game provider 116 updates the opt-out source with the update's game pieces. Referring to FIG. 1, in some examples, the opt-out HTTP source 114 is the same source as the seeder redirect source 114. In this opt-out scenario, the opt-out HTTP source 114 uses low-throughput to discourage clients from directly contacting it.

### Termination of Peer Connection

Peer connections between two swarm members terminate when both the members have completed their respective updates. Therefore, because swarm members are capable of continuously receiving new game pieces, the peer connection remains open if at least one swarm member has not completed its update even if the other members do not have the needed game pieces. This ensures availability of the peer connection if, in the future, a swarm member comes to host a piece that another connected swarm member requires.

### End Game

When a download is almost complete, there is a tendency for the last few game pieces to download more slowly. To avoid this, the updating client sends requests for all of its missing game pieces to all of its peers, and upon receiving a game piece, sends a cancel message for that game piece to its peers. This process is referred to as “end game.” Some updating swarm members enter end game when all game pieces have been requested. Others wait until the number of game pieces still needed is lower than the number of data pieces in transit.

A number of embodiments of the invention have been described. Nevertheless, it will be understood that various modifications may be made without departing from the spirit and scope of the invention. Accordingly, other embodiments are within the scope of the following claims. In one example, the same physical machine includes a the status server, seeder, tracker, meta data HTTP source or any combination thereof. In other examples, the foregoing logical elements are distributed across two or more physical machines in data communication with each other.

Although the updating process has been described with reference to missing game pieces, it is understood that the above description is also applicable to the updating of different game pieces. For example, a second update may add new features or functionality to the prior game pieces. However, the second update need not change the number of game pieces included in a version. Instead, this second update replaces the prior games pieces with new games pieces that include the new features or functionality. Therefore, these different game pieces include replacement game pieces.

While the updating process has been described with reference to updating a run time version of game software, it is to be understood that the updating process described herein applies to updating all types of software, including updating versions of software and updating missing or different software pieces that are part of a software update or any combination thereof.

What is claimed is:

1. A computer-implemented method for updating a run-time version of game software stored on a first storage location, the method comprising:
causing a first swarm member to store a first version of the game software on the first storage location, the first version having a first plurality of game pieces;
maintaining a second version of the game software, the second version having a second plurality of game pieces, at least one of the game pieces missing from the first plurality of game pieces;
receiving, from the first swarm member, a request to upgrade to the second version of the game software, the request identifying the first version;
on the basis of the identity of the first version, identifying a set of missing game pieces, the set including game pieces required to upgrade from the first version to the second version; and
providing, to the first swarm member, information leading to a subset of other swarm members, each of the other swarm members from the subset hosting at least one of the missing game pieces at a second storage location used for storing a run-time version of the game software;
whereby the first swarm member receives the ability to identify other swarm members belonging to the subset and request missing game pieces therefrom;
causing the first swarm member to retrieve the missing game pieces from the second storage location and to store them in at least a portion of the first storage location that was used to store the first version of the game software, thereby avoiding consumption of additional storage during the update of the game software.

2. The method of claim 1, wherein causing the first swarm member to retrieve the missing game pieces comprises retrieving one or more game pieces corresponding to updates for versions between the first version of the run-time game software and the second version.

3. The method of claim 1, further comprising:
receiving, from one or more of the other swarm members, a message identifying the swarm member as hosting a version of the game software; and
generating a list of the game versions hosted by the one or more swarm members.

4. The method of claim 3, further comprising:
comparing the second version included in the first swarm member's request to upgrade and the list containing the game versions hosted by the other swarm members; and
based on the comparison, identifying a subset of other swarm members hosting at least one of the game pieces included in the second version.
receiving a message from the first swarm member upon receipt of a missing game piece, wherein the message includes the version of the game software associated with the game piece.

5. The method of claim 1, further comprising:
receiving a message from the first swarm member upon receipt of a missing game piece, wherein the message includes the version of the game software associated with the game piece

6. The method of claim 1, wherein causing the first swarm member to retrieve the missing game pieces comprises retrieving one or more game pieces associated with the most recent version of the game software.

7. The method of claim 1, further comprising:
causing the first swarm member to share retrieved games pieces with other members of the swarm directly from the first swarm member's first storage location.

8. The method of claim 1, further comprising:
transferring between swarm members one or more game pieces in an in-place update, wherein a state of the game piece during transfer and the state of the piece after transfer, as used by the game software, are the same.

9. The method of claim 1, wherein causing the first swarm member to store the missing game pieces in at least a portion of the first storage location further comprises:
causing the first swarm member to store the missing game pieces in a location from which the missing game pieces will be accessed during play of the game.

10. The method of claim 1, wherein causing the first swarm member to retrieve the missing game pieces further comprises:
causing the first swarm member to establish a connection with the one or more other swarm members; and
causing the first swarm member to terminate the connection when the first swarm member and the other connected swarm member have retrieved all missing game pieces.

11. The method of claim 1, wherein the missing game pieces include one or more game pieces that are absent from the first version of the game software.

12. The method of claim 1, wherein the missing game pieces include one or more replacement game pieces for the first plurality of game pieces.

13. The method of claim 1, wherein the first version is a version that immediately precedes the second version.

14. The method of claim 1, wherein at least a third version exists between the first and second versions.

15. The method of claim 1 further comprising:
providing, to the first swarm member, information leading to an identification of one or more machines hosting at least one of the missing game pieces at a third storage location used for storing the run-time version of the game software;
whereby the first swarm member receives the ability to request missing game pieces therefrom; and
causing the first swarm member to retrieve the missing game pieces from the third storage location and to store them in at least a portion of the first storage location that was used to store the first version of the game software.

16. A computer-readable medium having encoded thereon software for updating a run-time version of game software stored on a first location, the computer program product comprising instructions for causing a computer to:
cause a first swarm member to store a first version of the game software on the first storage location, the first version having a first plurality of game pieces;
maintain a second version of the game software, the second version having a second plurality of game pieces, at least one of the game pieces missing from the first plurality of game pieces;
receive, from the first swarm member, a request to upgrade to the second version of the game software, the request identifying the first version;
on the basis of the identity of the first version, identify a set of missing game pieces, the set including game pieces required to upgrade from the first version to the second version; and
provide, to the first swarm member, information leading to a subset of other swarm members, each of the other swarm members from the subset hosting at least one of the missing game pieces at a second storage location used for storing a run-time version of the game software;
whereby the first swarm member receives the ability to identify other swarm members belonging to the subset and request missing game pieces therefrom;
cause the first swarm member to retrieve the missing game pieces from the second storage location and to store them in at least a portion of the first storage location that was used to store the first version of the game software, thereby avoiding consumption of additional storage during the update of the game software.

17. The computer-readable medium of claim 16, wherein the instructions for causing retrieval of the missing game pieces comprise instructions for retrieving game pieces for updates for versions between the first version of the run-time game software and the second version.

18. The computer-readable medium of claim 16, wherein the software further comprises instructions for causing a computer to:
receive, from one or more of the other swarm members, a message identifying the swarm member as hosting a version of the game software; and
generate a list of the game versions hosted by the one or more swarm members.

19. The computer-readable medium of claim 18, wherein the software further comprises instructions for causing a computer to:
compare the second version included in the first swarm member's request to upgrade and the list containing the game versions hosted by the other swarm members; and
based on the comparison, identify a subset of other swarm members hosting at least one of the game pieces included in the second version.

20. The computer-readable medium of claim 16, wherein the software further comprises instructions for causing a computer to:
receive a message from the first swarm member upon receipt of a missing game piece, wherein the message includes the version of the game software associated with the game piece.

21. The computer-readable medium of claim 16, wherein the software for causing the retrieval of the missing game pieces comprises instructions for retrieving game pieces associated with the most recent version of the game software.

22. The computer-readable medium of claim 16, wherein the software further comprises instructions for causing a computer to:
cause the first swarm member to share retrieved games pieces with other members of the swarm directly from the first swarm member's first storage location.

23. The computer-readable medium of claim 16, wherein the software further comprises instructions for causing a computer to:
transfer between swarm members one or more game pieces in an in-place update, wherein a state of the game piece during transfer and the state of the piece after transfer, as used by the game software, are the same.

24. The computer-readable medium of claim 16, wherein the instructions for causing a computer to cause the first swarm member to store the missing game pieces in at least a portion of the first storage location comprise instructions for causing a computer to:
cause the first swarm member to store the missing game pieces in a location from which they will be accessed during play of the game.

25. The computer-readable medium product of claim 16, wherein the instructions for causing a computer to cause the first swarm member to retrieve the missing game pieces comprise instructions for causing a computer to:
cause the first swarm member to establish a connection with the one or more other swarm members; and
cause the first swarm member to terminate the connection when the first swarm member and the other connected swarm member have retrieved all missing game pieces.

26. The computer-readable medium of claim 16, wherein the instructions for retrieving missing game pieces comprise instructions for retrieving one or more game pieces absent from the first version of the game software.

27. The computer-readable medium of claim 16, wherein the missing game pieces include one or more replacement game pieces for the first plurality of game pieces.

28. The computer-readable medium of claim 16, wherein the first version is a version that immediately precedes the second version.

29. The computer-readable medium of claim 16, wherein at least a third version exists between the first and second versions.

30. The computer-readable medium of claim 16, wherein the software further comprises instructions for causing a computer to:
provide, to the first swarm member, information leading to an identification of one or more machines hosting at least one of the missing game pieces at a third storage location used for storing the run-time version of the game software;
whereby the first swarm member receives the ability to request missing game pieces therefrom; and
cause the first swarm member to retrieve the missing game pieces from the third storage location and to store them in at least a portion of the first storage location that was used to store the first version of the game software.
